(19) United States
(12) Patent Application Publication
(10) Pub. No.: US 2022/0034057 A1
(43) Pub. Date: Feb. 3, 2022

(54) DOCK BUMPER

(71) Applicant: Trim-Gard Company Limited, London (CA)

(72) Inventor: Monte Goble, London (CA)

(21) Appl. No.: 17/388,335

(22) Filed: Jul. 29, 2021

Related U.S. Application Data
(60) Provisional application No. 63/058,152, filed on Jul. 29, 2020.

(51) Int. Cl. E02B 3/26; F21V 33/00

(52) U.S. Cl. CPC E02B 3/26; F21W 2111/04; F21V 33/006

(57) ABSTRACT

A dock bumper that protects boats from being damaged when they are moored to a dock is provided. The dock bumper incorporates a clear, transparent lens which allows a light emitting diode (LED) rope light to shine through, and it incorporates a support member to hold the LED rope light in place. The dock bumper of the present disclosure makes it much safer to dock a boat in poor light conditions (night, fog etc.). The dock bumper of the present disclosure may also be used to protect vehicles such as water vehicles, land vehicles and air vehicles, from damage when hitting a hard surface.

### CROSS-REFERENCE TO RELATED APPLICATIONS

This application claims priority to U.S. Provisional Patent Application No. 63/058,152 filed Jul. 29, 2020, which is incorporated by reference herein in its entirety.

### FIELD OF THE INVENTION

The present invention relates to a dock bumper, more particularly to a dock bumper having a LED rope light.

### BACKGROUND OF THE INVENTION

Dock bumpers need to be easy to be seen by a water vehicle operator and be able to withstand marine environment and prevent damage to the water vehicles that engage the dock bumpers.

U.S. Pat. No. 6,095,074 describes an illuminated dock bumper that includes a rectangular slot that houses an illumination source. The illumination source is not covered and, therefore, it is exposed to the harsh marine environment. In addition, the rectangular slot is located on the dock engaging side of the bumper, and is susceptible to being break when bumped by a boat.

### SUMMARY OF THE INVENTION

In one embodiment, the present disclosure provides for a dock bumper having a light emitting diode (LED) rope light and a clear transparent lens covering the LED rope light which allows a LED rope light to shine through.

In one embodiment, the dock bumper further includes an angled support member to hold the LED rope light in place.

In another embodiment of the dock bumper of the present disclosure, the dock bumper further includes an upper chamber that houses the LED rope light, and a lower chamber, and wherein the internal angled support member separates the upper chamber from the lower chamber.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The present invention will become more fully understood from the detailed description given herein and from the accompanying drawings, which are given by way of illustration only and do not limit the intended scope of the invention.

FIG. 1 illustrates a cross-section of dock bumper in accordance with an embodiment of the present disclosure.

FIG. 2 illustrates a front view of dock bumper in accordance with an embodiment of the present disclosure.

FIG. 3 illustrates a view of a dock bumper attached to a dock in accordance with an embodiment of the present disclosure.

FIG. 4 illustrates a cross-section view of a dock bumper in accordance with an embodiment of the present disclosure.

### DETAILED DESCRIPTION OF THE INVENTION

The present disclosure describes a dock bumper that protects boats from being damaged when they are moored to a dock. The dock bumper incorporates a clear, transparent lens which can be a plastic lens, which allows a light emitting diode (LED) rope light to shine through, and it incorporates a support member to hold the LED rope light in place. The dock bumper of the present disclosure makes it much safer to dock a boat in poor light conditions (night, fog etc.). The dock bumper of the present disclosure may also be used to protect vehicles such as water vehicles, land vehicles and air vehicles, from damage when hitting a hard surface.

When the articles “a,” “'an,” “one,” “the,” and “said” are used herein, they mean “at least one” or “one or more” unless otherwise indicated.

The terms “comprising,” “including,” and “having” are intended to be inclusive and mean that there may be additional elements other than the listed elements.

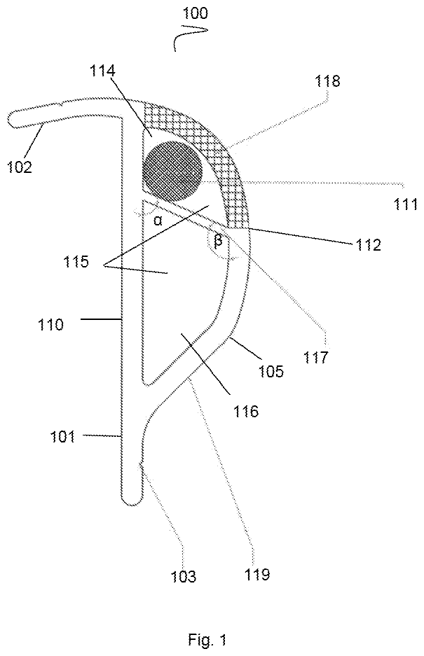

Referring to FIG. 1, there is illustrated therein a dock bumper 100 in accordance to one embodiment of the present disclosure. The bumper 100 is intended for protection of boats from being damaged when they are moored to a dock. The dock bumper 100 can be attached to a dock or a dock vehicle. The dock bumper 100 comprises a hollowed housing 105 that stores a LED rope light 111 and a clear, transparent covering lens 118 covering the LED rope light 111. In one embodiment, the clear covering lens 118 and the LED rope light 111 run an entire longitudinal length of the hollowed housing 105.

As shown in FIG. 2, the dock bumper may extend along one or more sides of a dock 200. The dock bumper may further extend along one or more sides of a vehicle, such as a boat, sea-doo, jet-ski, or non motorized vehicle such as a canoe or kayak or other water vehicle.

The dock bumper 100 may include port(s) 202 at one or more of its ends that are operable to open and allow access to the LED rope light, whereby the LED rope light be replaced. One or more of the ports 202 may further incorporate a connection whereby the LED rope light may be connected to an electrical wire.

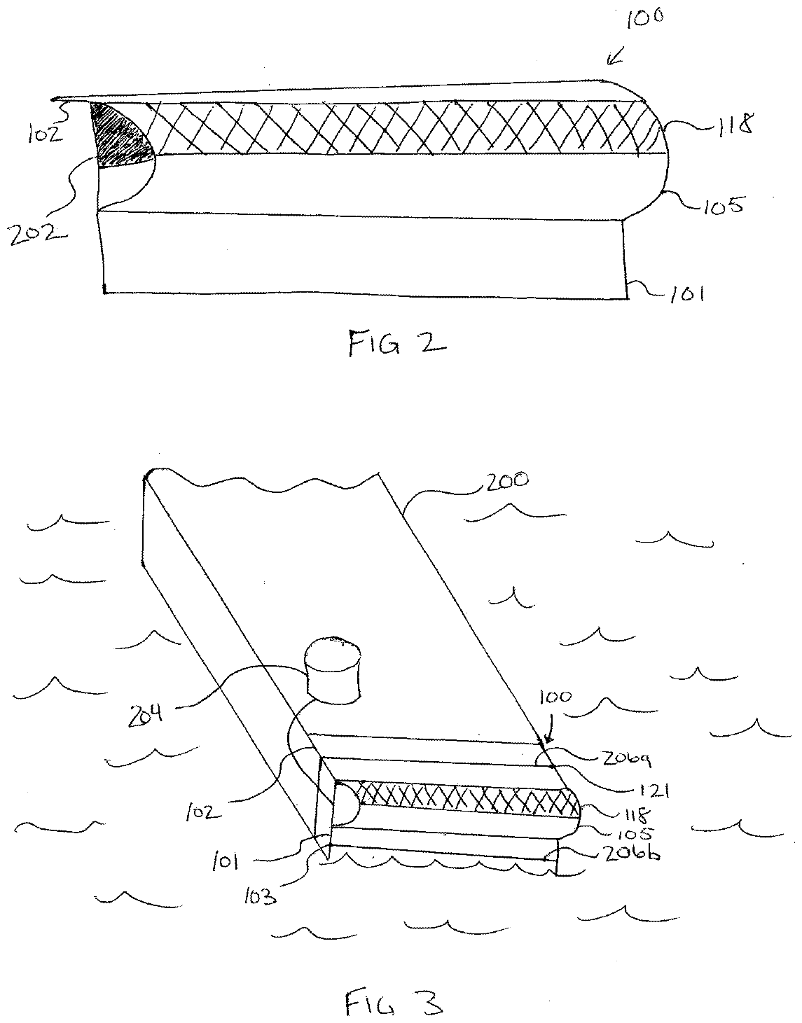

In embodiments of the present invention, the dock bumper of the present disclosure may include a source of energy 204, that may be a 12V power source, a solar powered battery, or other source of energy for powering the LED rope light. The source of energy 204 may be incorporated within the dock bumper in some embodiments or external to the dock bumper in other embodiments, as shown in FIG. 3.

The housing 105, which is water-proof, as shown in FIG. 1, incorporates an interior or back wall 110 for attachment to a dock or to a vehicle, and a front or exterior wall 112 for absorbing forces when engaging with a dock or with a boat or other water vehicle. Interior wall 110 is substantially planar in shape, while the wall 112 is substantially curved in shape so that a cross section of body 105 is about hemispherical in shape. Interior and exterior walls 110 and 112 define a cavity 115 that includes a rib or support member 117 that extends from interior wall 110 to exterior wall 112. Rib 117 divides cavity 115 into an upper, waterproof chamber 114 and a lower chamber 116, which may also be waterproof. The surface of the interior wall 110 that line the upper chamber 114 and the lower chamber 116 is straight. Upper chamber 114 houses the LED rope light 111, and may be filled with a gaseous composition, such as air. Optionally, the surfaces lining of the upper chamber 114 may be painted of a color that facilitates the reflection of light emitted by the LED rope 111. The lower chamber 116, which may also be waterproof, is filled with a gaseous composition, such as air, or filled with a composition that is capable of absorbing an impact, such as a foam, air or other cushioning material. Support member 117 is intended to give structural integrity to the cavity 115 from collapsing when impacted as well as to provide support and protection to the LED rope light within chamber 114. In one embodiment, one end rib 117 forms an angle α of about 60° to 90° with the interior surface 110, while the opposite end of rib 117 forms an angle β of about 90° to 120° with the exterior wall 112. Preferably, support member 117 is angled, with angle α being about 70° and angle β being about 110°, thereby forming an angled support member 117. When attached to a dock, the LED chamber 114 is positioned on top of the chamber 116. In one embodiment, the surfaces lining the LED chamber 114 (other than the lens 118) may include a reflective plate. By being positioned on the top side of the bumper 100, the LED rope light 111 within the LED chamber 114 is less susceptible to being broken by a water vehicle. The support member 117 and the lens 118 provide extra protection to the LED rope light from being broken.

The dock bumper 100 is a plastic co-extruded (two polymer plastics). The section or portion of the exterior wall 112 that covers the LED chamber 114 is a lens 118 composed of a clear plastic lens designed to focus and/or transmit the light emitted by the LED rope. The lens 118 may also serve to protect the LED from water and from impacts. The remainder of the dock bumper 100, including the section or portion 119 of the exterior wall 112 that covers chamber 116, is composed of a material that is flexible and resilient to cushion a boat such as to prevent damage thereof such as a flexible thermos-plastic.

In one embodiment, the dock bumper 100 may include flaps 101, 102 having one or more fastener locators 103 for fastening the dock bumper 100 to the dock. The fastener locators 103, 121 are notches in said flaps, whereby one or more connectors 206a, 206b, such as rope or other connectors, can be positioned to fasten or releasably secure the dock bumper to the dock, as shown in FIG. 3, or to a vehicle.

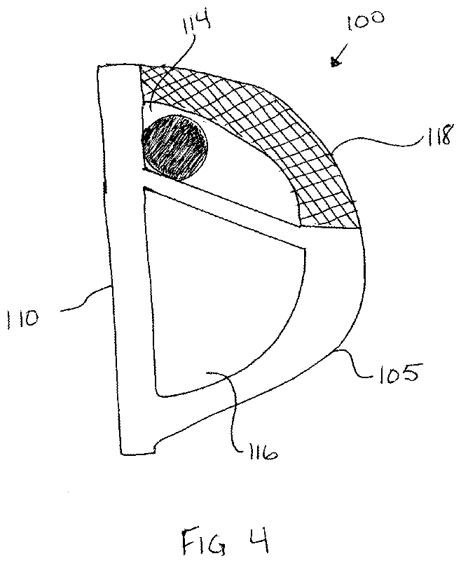

As shown in FIG. 4, in other embodiments the dock bumper 100 may not include flaps 101, 102. When the bumper 100 is intended for connecting to an edge of a dock, then the bumper includes a flap 102 that extends laterally from the interior wall 110. In one embodiment, the entire dock bumper 100, including flaps 101 and 102 if provided, is an integral, unitary unit.

The LED rope 111 may change colors and brightness and be controlled remotely, with timers, a control panel or wirelessly through an electronic device such as cellular phones, tablets, laptops, desktops and so forth.

In view of the above, it will be seen that the several objects of the invention are achieved and other advantageous results attained. As various changes could be made in the above devices without departing from the scope of the invention, it is intended that all matter contained in the above description and shown in the accompanying drawing shall be interpreted as illustrative and not in a limiting sense.

We claim:

1. A dock bumper comprising a housing incorporating a light emitting diode (LED) rope light and a lens covering the LED rope light whereby light emitted by the LED rope light shines through said clear lens.

2. The dock bumper of claim 1, wherein the dock bumper further incorporates an internal angled support member operable to hold the LED rope light in place within the housing.

3. The dock bumper of claim 1, wherein the dock bumper further incorporates an upper chamber that houses the LED rope light, and a lower chamber, and wherein the internal angled support member separates the upper chamber from the lower chamber.

4. The dock bumper of claim 1, wherein the dock bumper further incorporates one or of more flaps, comprising an upper flap extending from an upper end of the interior wall and a lower flap extending from a lower end of the interior wall.

5. The dock bumper of claim 4, wherein one or more of the one or more flaps incorporates a notch, whereby a connector can be positioned to be operable to connect the dock bumper to a dock or a vehicle.

6. The dock bumper of claim 1, wherein the dock bumper further incorporates a chamber in the housing that is removed from area in the housing that incorporates the LED rope light, and said chamber is filled with a gaseous composition that is operable to absorb an impact.

7. The dock bumper of claim 6, wherein in the gaseous composition is air or foam.

8. The dock bumper of claim 1, wherein the dock bumper is waterproof.

9. The dock bumper of claim 1, wherein the dock bumper is formed of a plastic co-extruded.

10. The dock bumper of claim 1, wherein the LED rope 111 is operable to change one or more of the following: colors or brightness.

11. The dock bumper of claim 1, wherein the housing is divided into two chambers by a rib.

12. The dock bumper of claim 11, wherein the rib has two ends and an end of the rib forms an angle α of about 60° to 90° with an interior surface of the housing, and the opposite end of the rib forms an angle β of about 90° to 120° with an exterior wall of the dock bumper.

13. The dock bumper of claim 1, wherein the housing further incorporates an interior wall that is substantially planar in shape, and is positioned in proximity to a side wall of a vehicle or dock to which the dock bumper is connected.

14. The dock bumper of claim 1, wherein the housing further incorporates an exterior wall that is substantially curved in shape and is positioned to be distant from a side wall of a vehicle or dock to which the dock bumper is connected.
